(19) United States
(12) Patent Application Publication
(10) Pub. No.: US 2026/0230477 A1
(43) Pub. Date: Aug. 6, 2026

(54) SYSTEMS AND METHODS FOR IMPROVING NETWORK SECURITY ACROSS COMPUTER NETWORKS WHEN GRANTING ACCESS ENTITLEMENTS TO A PLURALITY OF APPLICATIONS

(71) Applicant: Capital One Services, LLC, McLean, VA (US)

(72) Inventors: Peter ZELLER, Groveland, FL (US); Jinlian WANG, Falls Church, VA (US)

(73) Assignee: Capital One Services, LLC, McLean, VA (US)

(21) Appl. No.: 19/046,321

(22) Filed: Feb. 5, 2025

(51) Int. Cl. H04L 9/40

(52) U.S. Cl. CPC H04L 63/102

(57) ABSTRACT

Systems and methods for improving network security across computer networks when granting access entitlements to a plurality of applications. For example, the system may receive, from a first account, a first access request for a first application entitlement. The system may retrieve a first access credential profile for the first account. The system may determine a first embedding for the first access credential profile. The system may retrieve a first required embedding for the first application entitlement. The system may determine a first dimensionality conflict between the first embedding and the first required embedding. The system may determine a dependency between the first dimensionality conflict and a credential attribute. The system may query the first account for the credential attribute.

### BACKGROUND

Different accounts in a computer network require access to different applications because users have varied roles, responsibilities, and operational needs within an organization. For example, a network analyst may need access to network monitoring tools, while a software developer requires development environments and repositories. This differentiation ensures that users can perform their specific duties effectively while maintaining the principle of least privilege—granting them access only to the applications and data necessary for their role. Customizing access for each account also supports organizational efficiency, compliance with regulations, and the safeguarding of sensitive information by preventing unnecessary or unauthorized access to critical systems.

To grant access, the computer network may maintain access entitlements, which may be predefined permissions or rights assigned to user accounts that determine their ability to access specific applications, resources, and/or features within a network. These entitlements serve as a mechanism to standardize and manage access across a plurality of applications, ensuring that users can only interact with systems in ways appropriate to their roles, responsibilities, and/or attributes. Entitlements can define granular levels of access, such as “read-only,” “write,” “admin,” or “execute,” and are often bundled into roles or policies that align with organizational needs.

### SUMMARY

Systems and methods are described herein for improving network security across computer networks when granting access entitlements to a plurality of applications. For example, to grant access to multiple applications, entitlements are typically aggregated into centralized systems like identity and access management (IAM) platforms. These systems manage and enforce entitlements using approaches such as role-based access control (RBAC) or attribute-based access control (ABAC). When a user attempts to access an application, the system checks their entitlements against the application's access policies to determine whether to grant or deny access.

Given the complex and shifting nature of modern computer networks as well as the rise in temporary authorization to different applications, access entitlements may need to be dynamically determined. To dynamically determine application entitlements, a system may use a model to compare known attributes for a user (e.g., “job title”) to a predefined list of entitlements corresponding to the known attributes. However, given the complexity of requirements for, and number of applications available, known attributes are typically not rich enough to derive a complete list of entitlements or distinguish between rules for specific access entitlements, or whether the system is relying on a manual or automatic approach. Moreover, due to the shear volume of data involved, systems and methods may require a model to embed and compare the data. In such cases, the missing dimensionality in the richness of the data that requires a cure (i.e., the attribute and/or characteristics required for an access entitlement) may not be apparent.

The systems and methods overcome this technical problem by using a supplemental metadata collection to determine additional attributes that may resolve any ambiguities, shortfalls, and/or conflicts when accessing entitlements. However, any supplemental metadata, and/or the collection thereof, must also be subject to a threshold level of trust. One solution to obtaining the supplemental metadata is to ping a user or system with a given level of trust when an ambiguity, shortfall, and/or conflict is detected. However, as mentioned above, the missing data may not be apparent. Moreover, simply searching for additional information may result is the received information, if found, being redundant or non-dispositive, which could lead to bias, overfitting, or no increase in model performance.

The systems and methods overcome this problem by smart searching for supplemental metadata. That is, the system identifies “tags” in the dimensionality of attributes used to assign entitlements. The system then determines missing “tags” (e.g., missing dimensionalities of data) that would resolve any ambiguities, shortfalls, and/or conflicts (e.g., dimensionality conflicts) when assigning access entitlements. The system may then determine one or more dependencies between the dimensionality conflict and an unknown credential attribute or a cluster of unknown credential attributes. The system may then generate a prompt for the unknown credential attribute (e.g., a question that asks a user or queries a database with a threshold level of trust for specific information that will “fill” the missing dimensionality and resolve the ambiguity, shortfall, and/or conflict). By doing so, the system applies the same level of security/trust to the supplemental metadata as to entitlements themselves. As an added benefit, because the tags are generated from the aforementioned bottom-up methodology, there is no way to “tag” shop (e.g., allow users to enter information that may result in unauthorized access entitlements), which further increases security.

In some aspects, systems and methods for improving network security across computer networks when granting access entitlements to a plurality of applications are described. For example, the system may receive, from a first account, a first access request for a first application entitlement. The system may retrieve a first access credential profile for the first account. The system may determine a first embedding for the first access credential profile. The system may retrieve a first required embedding for the first application entitlement. The system may determine a first dimensionality conflict between the first embedding and the first required embedding. The system may determine a dependency between the first dimensionality conflict and a credential attribute. The system may query the first account for the credential attribute.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for granting access entitlements to a plurality of applications, in accordance with one or more embodiments.

FIG. 2 shows an illustrative diagram for requesting supplemental metadata to access an entitlement, in accordance with one or more embodiments.

FIG. 3 shows illustrative components for a system used to identify supplemental metadata and generate queries for the supplemental metadata, in accordance with one or more embodiments.

FIG. 4 shows a flowchart of the steps involved in improving network security across computer networks, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods are described herein for improving network security across computer networks when granting access entitlements to a plurality of applications. For example, to grant access to multiple applications, entitlements are typically aggregated into centralized systems like identity and access management (IAM) platforms.

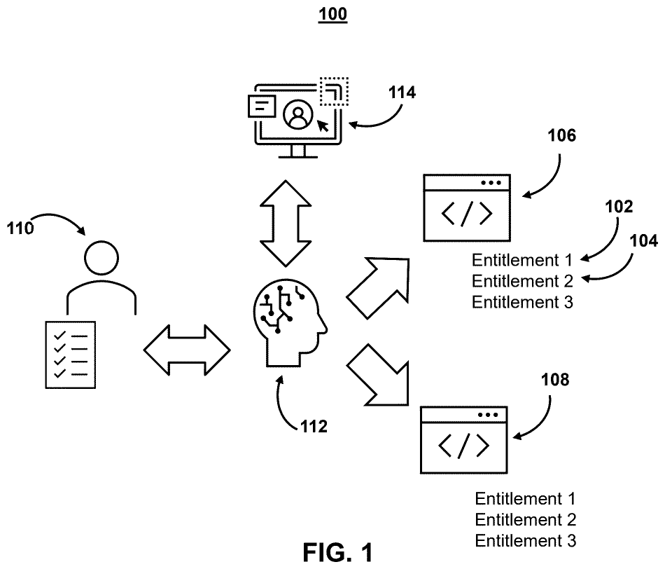

FIG. 1 shows an illustrative diagram for granting access entitlements to a plurality of applications, in accordance with one or more embodiments. FIG. 1 shows system 100, which may be an IAM platform. These systems manage and enforce entitlements using approaches such as role-based access control (RBAC) or attribute-based access control (ABAC). When a user attempts to access an application, the system checks their entitlements against the application's access policies to determine whether to grant or deny access.

System 100 may grant specific entitlements (e.g., entitlement 102 or entitlement 104) for different applications (e.g., application 106 or application 108). Granting different applications specific entitlements for each account involves identity management, access control, and secure communication mechanisms. The system may rely on core components, including a user or account profile that includes user/account information (e.g., username, email, or unique identifier), roles, and group memberships, which define access permissions. These attributes, along with application-specific policies, may be used by system 100 to determine the entitlements assigned to each user and/or account (e.g., user profile 110). Access control policies, such as role-based or attribute-based access control (RBAC or ABAC), govern permissions, utilizing user roles, groups, and contextual attributes like department, clearance level, or device type.

For example, the system uses smart searching for supplemental metadata to overcome the technical challenge of managing complex entitlement rules by dynamically integrating trusted system-defined (SD) attributes, user-defined (UD) attributes, and automated rule discovery. This approach ensures that access entitlements are assigned efficiently and accurately while incorporating adaptive learning through clustering algorithms to refine and expand rules over time.

For example, when a new user joins, the system processes their SD attributes (e.g., SDDept=341 and SDJR=107) against predefined rules. The rules engine may evaluate the user's attributes and uses the first matching rule: “If SDDept=341 AND SDJR=107→Grant Ent1, Ent2, Ent3, Ent4, Ent5.” The system may provision the entitlements immediately. As no user-defined attributes (UD) exist at this stage, so no further rules execute.

In some embodiments, system 100 may dynamically generate entitlements. For example, system 100 may dynamically generate a list of new entitlements for each target application by leveraging a combination of identity attributes, contextual metadata, and predefined policies. The process begins by analyzing the identity's attributes, such as job title, department, location, and role, which provide a baseline for entitlement eligibility. System 100 may then incorporate supplemental metadata collected through custom-built user experience (UX) workflows. This metadata might include inputs from managers, responses to conditional queries, or details about specific job functions and operational requirements. By integrating these data points, system 100 creates a context-aware, customized entitlement profile tailored to the application's requirements.

For example, as the user's role evolves, the system, manager, or HR representative may automatically or manually update their profile by adding UD attributes: “UDTAG1=‘Night Shift’; UDTAG2=‘Repo Specialist,’” which may be validated against eligible departments, ensuring security. Upon updating these attributes, the system re-evaluates the rule set and detects new applicable rules: “If SDDept=341 AND SDJR=107 AND UDTAG1=‘Night Shift’→Grant Ent6, Ent7” and “If SDDept=341 AND SDJR=107 AND UDTAG1=‘Night Shift’ AND UDTAG2=‘Repo Specialist’ →Grant Ent8, Ent9.”

Because these attributes trigger new access entitlements, the system may initiate approval requests. For example, before granting new entitlements, approvals are sent such that the user's manager sees the tags being requested and the associated entitlements. Additionally or alternatively, business owners of Ent6, Ent7, Ent8, and Ent9 are notified for approval, preventing unauthorized access. Once approved, tags are written to the user profile. The next rule engine execution automatically grants access based on updated attributes. If tags are later removed, entitlements associated with them are revoked.

Once the list of entitlements is generated, system 100 may automatically push these updates to the target application via APIs, SDKs, or identity and access management (IAM) platforms. This ensures that the application has an up-to-date and accurate representation of the user's access rights. The workflow is further streamlined by reducing the complexity of entitlement certification for managers. Instead of manually reviewing extensive and potentially redundant access requests, user may be presented by system 100 with a concise, curated list of identity attributes and collected metadata to approve or refine. This reduces administrative overhead and increases efficiency while maintaining security. This dynamic and metadata-driven approach also simplifies the recertification process, particularly during mover events when an identity transitions between job roles. The system automatically identifies changes in attributes or metadata, evaluates the impact on entitlements, and adjusts access rights accordingly. This ensures a smoother transition, minimizing disruptions to productivity and reducing the risk of inappropriate access. By automating and refining the process through dynamic entitlement generation and metadata integration, organizations can improve security, enhance operational efficiency, and provide a more scalable solution for access management.

System 100 may begin with user authentication through methods such as passwords, multi-factor authentication (MFA), or biometrics via a user interface. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

Once authenticated, the system may retrieve the user's profile comprising user information, account information, associated roles, groups, and/or other attributes. The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

A centralized logic engine (e.g., model 112) may evaluate access requests against predefined policies, considering contextual data like time or location. The resulting decision may be enforced by the Policy Enforcement Point (PEP), ensuring resources are accessed appropriately. To facilitate data exchange, the system may employ standards and protocols such as OAuth 2.0, OpenID Connect (OIDC), SAML (Security Assertion Markup Language), and JSON Web Tokens (JWT). Identity providers (IdPs) may manage user identities and provide authentication and authorization data to applications. These providers often integrate with directory services like LDAP or Active Directory (AD), which store user information, roles, and entitlements. Applications use APIs or SDKs to retrieve entitlements and enforce access controls. The workflow may also involve user authentication via an identity provider, which issues a token (e.g., OAuth access token or SAML assertion). This token is validated by the application or resource server to retrieve entitlement information. The system evaluates whether the requested action aligns with the user's entitlements and policies, then enforces the decision by granting or denying access.

Entitlements (e.g., entitlement 102 or entitlement 104) may be represented as metadata in tokens (e.g., OAuth scopes or SAML assertions), which are passed to applications during the authentication and authorization process. By standardizing and automating entitlement assignments, system 100 can efficiently manage access to a broad range of applications, reducing administrative overhead and ensuring security compliance while maintaining operational efficiency.

Model 112 may determine the level of access based on predefined policies, roles, or attributes associated with the user account. These restrictions may be enforced using role-based access control (RBAC), where permissions are tied to user roles, or attribute-based access control (ABAC), which considers a broader set of contextual attributes such as department, location, or device type. Additionally, network segmentation, firewalls, and access control lists (ACLs) can limit application access based on the user's account or device. For sensitive applications, system 100 may make access contingent on dynamic conditions, such as time of access, geolocation, or device security posture. By implementing these measures, system 100 can ensure that only authorized accounts access specific applications, reducing the risk of data breaches and maintaining operational integrity.

For example, to retrieve an access credential profile for an account and address a dependency involving dimensionality conflicts and credential attribute clusters with a specific trust level, the system may first query its database or identity management framework for the account's associated credential data. This access credential profile comprises multiple pieces of credential data, such as authentication tokens, permissions, roles, or attributes, each categorized by predefined trust levels. The system identifies the trust level of the retrieved profile—in this case, the first trust level—and evaluates its compatibility with the requested operations or data.

Next, the system analyzes the relationship between the credential data in the profile and the dimensionality conflict, which may arise from discrepancies in how attributes or metadata are structured, formatted, or validated. Using dependency modeling, the system determines how the conflict impacts or interacts with the credential attribute cluster associated with the same trust level. This may involve assessing metadata interdependencies, resolving conflicting data schemas, or reconciling overlapping permissions within the trust framework. By addressing these dependencies, the system ensures consistent alignment between the access credential profile, the trust level, and the operational requirements, thereby maintaining secure and coherent access to resources.

In some instances, granting entitlements for specific applications by model 112 becomes technically challenging when only general account attributes are available because these attributes may lack the granularity needed to differentiate entitlements accurately across diverse systems. One common assumption in entitlement assignment may be that the known account attributes, such as job titles, department names, or location, are detailed enough to derive a complete list of entitlements or distinguish between entitlements for different applications. However, this assumption often fails, particularly in large-scale IT operations or enterprises where many users share similar roles or attributes. For instance, two employees with the same job title in different departments might require access to entirely different systems or data sets, but generalized attributes like “job title” or “location” cannot capture these nuances. Moreover, complex systems often impose their own entitlement models and require detailed, application-specific policies that cannot be easily inferred from broad account attributes. This creates a disconnect between the attributes available in identity systems and the granularity needed to satisfy the unique requirements of various target systems. The result is either over-provisioning, which introduces security risks, or under-provisioning, which hampers productivity. Bridging this gap often requires additional layers of attribute mapping, policy definition, or manual intervention, which can add significant complexity to entitlement management in large-scale operations.

To bridge this gap, model 112 may use supplemental metadata (e.g., metadata 114). Supplemental metadata, such as additional layers of attribute mapping, policy definitions, or manually curated data, can help bridge the gap between general account attributes and the specific entitlement requirements of diverse systems by providing the necessary context and granularity. Attribute mapping involves creating detailed relationships between high-level account attributes and the precise entitlements required for each application. Policy definitions add rules that account for nuances, such as conditional access based on specific combinations of attributes or contextual data like location or device type. Manual intervention, while labor-intensive, allows for resolving edge cases and creating tailored access configurations when automated processes fall short. Together, these supplemental layers enrich the decision-making process, ensuring entitlements are assigned more accurately and securely across systems.

For example, users may still manually request entitlements outside the system's automation. For example, in the example above, the user may request “Ent10” and “Ent11.” These requests may follow the normal approval workflow. If approved, they are granted manually without modifying the rules engine. Additionally or alternatively, the system may employ machine learning (ML)-based clustering to identify patterns in access provisioning. For example, if the system detects that 90% of users with the same SD and UD attributes have Ent10. The system flags this insight and notifies the business owner of Ent10, asking whether: “Ent10 should be incorporated into the existing rule.” If approved, Ent10 is added to the rule, ensuring future users meeting these attributes receive it automatically. The remaining 10% of eligible users without Ent10 receive it in the next rule execution.

Model 112 may significantly reduce the complexity of leveraging supplemental metadata in entitlement management, particularly in large-scale operations. By analyzing patterns in access requests, historical entitlement assignments, and organizational data, model 112 can automatically infer rules, generate attribute mappings, and identify gaps in existing policies.

In some embodiments, model 112 may be a machine learning and/or artificial intelligence model. Machine learning models can predict entitlement requirements for new accounts or applications, using clustering and classification techniques to group similar accounts and recommend entitlements. Natural language processing (NLP) can streamline the creation of policies by translating human-readable rules into enforceable machine policies. Furthermore, AI-powered analytics can continuously monitor and optimize entitlements, identifying anomalies, reducing over-provisioning, and highlighting opportunities for improvement. By automating these processes and providing intelligent recommendations, AI not only simplifies the use of supplemental metadata but also enhances scalability, accuracy, and security in entitlement management.

Creating an AI system for entitlement management is challenging due to the complexity, variability, and security-critical nature of the task. Entitlement requirements often differ significantly across organizations, applications, and roles, making it difficult to create a one-size-fits-all model. AI systems must account for highly nuanced factors, such as conditional access rules, edge cases, and evolving organizational policies, while ensuring that they do not inadvertently grant excessive or inappropriate access, which could lead to security breaches. Additionally, the scarcity of labeled training data poses a significant hurdle. Organizations may not have detailed records of historical entitlement decisions, or those records may be incomplete, inconsistent, or outdated. Furthermore, balancing security and usability while minimizing false positives and negatives requires a deep understanding of contextual and organizational nuances, which AI systems struggle to generalize without sufficient data.

Training data can be generated by system 100 to mitigate these challenges by synthesizing realistic scenarios and leveraging existing access logs. Historical access patterns, role-based entitlement assignments, and system audits can serve as a starting point for supervised learning models. Model 112 can also simulate different access request scenarios, defining the “ground truth” manually to provide clear labels for training data. Collaboration across organizations within the same industry can lead to shared, anonymized datasets that encapsulate common access patterns while preserving privacy. Additionally, reinforcement learning techniques can be used, allowing model 112 to explore and learn entitlement decisions through trial and error in a controlled environment. By enriching the training data with both real-world and synthetic examples, organizations can provide model 112 with a broader and more representative foundation, enabling them to learn effectively and perform accurately in complex, large-scale entitlement management tasks.

System 100 may synthesize realistic scenarios and leverage existing access logs to generate training data by processing and transforming historical records, role-based entitlement assignments, and system audits into structured, labeled datasets that reflect real-world access patterns. To begin, system 100 may analyze access logs to extract key details, such as the identities involved, the resources accessed, the context of access (e.g., time, location, device), and the outcome of access requests (granted or denied). This raw data is then cleaned and normalized to ensure consistency, removing duplicate or incomplete entries and standardizing formats.

Next, system 100 maps historical access patterns to predefined roles, attributes, or contextual factors, identifying commonalities and anomalies. For instance, it might group similar access events by job title, department, or access frequency to establish baseline behaviors. Role-based entitlement assignments are further enriched by correlating them with system-specific entitlements, creating granular mappings that link user attributes to specific permissions within different applications.

To synthesize new scenarios, system 100 can introduce variations in these historical patterns to simulate edge cases or potential future scenarios. For example, system 100 may adjust context variables, such as simulating access requests from unusual locations or during off-hours, to create examples of both valid and invalid access. System audit logs, which record compliance checks and incidents, are also invaluable for generating data about unauthorized access attempts, policy violations, or revocation events, providing labeled examples of undesirable behaviors.

Finally, the processed and synthesized data is labeled with outcomes (e.g., whether access was permitted, denied, or flagged for review) based on existing policies or manual annotations. This labeled dataset serves as a foundation for training model 112, enabling it to learn patterns, predict entitlements, and identify deviations. By systematically extracting, enhancing, and simulating data from historical records, the system creates a robust dataset that reflects the complexity and variability of real-world entitlement management scenarios, while also preparing model 112 to handle new and unexpected cases.

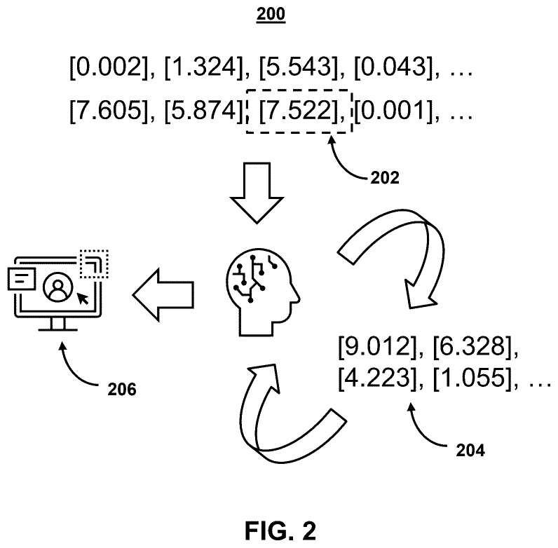

FIG. 2 shows an illustrative diagram for requesting supplemental metadata to access an entitlement, in accordance with one or more embodiments. For example, the system may use supplemental metadata (e.g., supplemental metadata 114 (FIG. 1)) to determine additional attributes that may resolve any ambiguities, shortfalls, and/or conflicts when accessing entitlements. For example, one solution to obtaining the supplemental metadata is to ping a user or system when an ambiguity, shortfall, and/or conflict is detected. However, as mentioned above, the missing data may not be apparent. Moreover, simply searching for additional information may result is the received information, if found, being redundant or non-dispositive, which could lead to bias, overfitting, or no increase in model performance.

The system may identify “tags” in the dimensionality of attributes used to assign entitlements. As shown in FIG. 2, system 200 may identify data within embedding 202 as corresponding to a required embedding for an application entitlement. An embedding of an access credential profile is a numerical representation of the attributes, entitlements, and characteristics associated with a user's access credentials, encoded in a way that preserves their relationships and patterns in a multi-dimensional space. This embedding allows systems to process and analyze access profiles more effectively, facilitating tasks such as identifying similar profiles, predicting entitlements, or detecting anomalies. Access credential embeddings are particularly useful in machine learning applications for entitlement management, where they enable models to generalize from existing patterns and make informed decisions about granting or restricting access.

Tags, such as those representing missing dimensionalities of data, ambiguities, or conflicts in assigning access entitlements, enhance security because they are generated using a bottom-up methodology that relies on systematic data analysis and predefined policies rather than user-provided input. In this approach, tags are automatically derived from the structured evaluation of access credential profiles, embeddings, and entitlement requirements. This ensures that tags accurately reflect objective discrepancies, such as missing attributes or misalignments, and are tied directly to the system's rules and models for resolving conflicts. Since the tags are generated algorithmically and based on validated data sources, they inherently avoid the risks associated with manual or arbitrary tagging. By eliminating the ability for users to “tag shop” that is, to manually enter or manipulate information to influence their access entitlements—this methodology prevents users from potentially bypassing security protocols to gain unauthorized access. In traditional systems where users can self-report or directly modify attributes, there is a risk that malicious actors or even well-intentioned but uninformed users might input inaccurate or fraudulent data to fulfill entitlement criteria. In contrast, the bottom-up approach ensures that tags are generated only after the system verifies data consistency and integrity, aligning them strictly with the access policies and dimensional requirements. This controlled and automated process not only enhances the accuracy of entitlement assignments but also reduces the likelihood of errors or exploitation, thereby significantly increasing security. By ensuring that tags are grounded in a robust evaluation framework and are immune to user influence, the system minimizes the risk of granting unauthorized access while maintaining compliance with organizational policies and standards.

To create an embedding, the access credential profile may be first represented by the system as a structured set of data points, such as user attributes (e.g., job title, department, location), entitlements (e.g., permissions, roles), and contextual metadata (e.g., access frequency, historical usage patterns). The system may transform these data points into vectors, using techniques like one-hot encoding, label encoding, or embedding layers in neural networks. For continuous attributes, normalization or scaling may be applied, while categorical attributes are mapped to dense numerical representations. A machine learning model, such as a neural network or word embedding algorithm (e.g., Word2Vec or transformers), may be trained on a dataset of access profiles to learn the relationships and similarities between attributes. The resulting embeddings capture these relationships in a compact, fixed-length vector format.

The embedding process may also incorporate additional techniques like dimensionality reduction (e.g., PCA or t-SNE) to simplify the representation while retaining its most critical features. Once created, the embeddings can be used for tasks such as clustering similar access profiles, recommending entitlements for new accounts, or identifying deviations from normal access behavior. By encoding access credential profiles into embeddings, organizations can leverage advanced analytics and machine learning to enhance access control, improve entitlement management, and strengthen security.

However, in some instances, the data in embedding 202 may be ambiguous, may be missing, and/or may otherwise cause a conflict (e.g., a dimensionality conflict between the data in embedding 202 and the required embedding). To determine the required embedding, the system may determine required supplemental metadata (e.g., metadata 204) used to cure the dimensionality conflict. For example, the system may determine missing “tags” (e.g., missing dimensionalities of data) that would resolve any ambiguities, shortfalls, and/or conflicts (e.g., dimensionality conflicts) when assigning access entitlements. The system may then determine one or more dependencies between the dimensionality conflict and an unknown credential attribute. The system may then generate a prompt (e.g., on user interface 206) for the unknown credential attribute (e.g., a question that asks a user or queries a database for specific information that will “fill” the missing dimensionality and resolve the ambiguity, shortfall, and/or conflict).

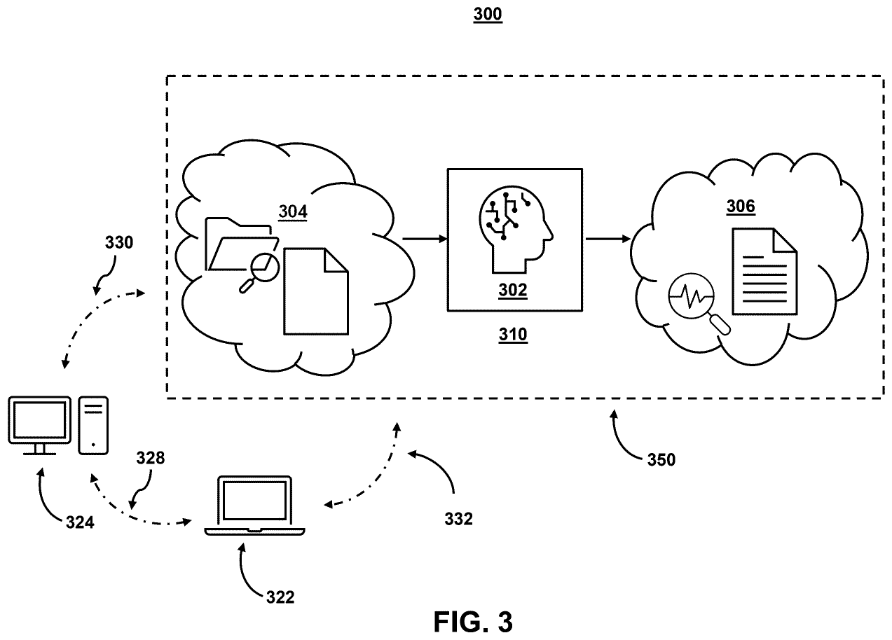

FIG. 3 shows illustrative components for a system used to identify supplemental metadata and generate queries for the supplemental metadata, in accordance with one or more embodiments. For example, system 300 may processing the plurality of credential data to determine an embedding for a plurality of credential data corresponding to a user and/or account, wherein the embedding comprises vector data. System 300 may also determine a required embedding for an application entitlement. System 300 may be trained to both compare the embeddings to required embeddings to determine whether to grant access to the application entitlement based on whether a dimensionality conflict between the first embedding and the first required embedding is present. System 300 may further determine how to cure the dimensionality conflict based on determining a dependency between the first dimensionality conflict and a new embedding for an additional credential attribute that may be requested by a user.

A system, such as system 300, may process a plurality of credential data to determine an embedding for a user or account by extracting and transforming relevant attributes into a numerical representation that captures the relationships and patterns within the data. This process begins with the ingestion of credential data, which includes identity attributes (e.g., job title, department, location), historical access patterns, and contextual metadata (e.g., device type or time of access). The system preprocesses the data by normalizing, encoding categorical variables, and scaling numerical attributes. These processed attributes are then fed into a trained machine learning model, such as a neural network with an embedding layer, to generate a vector-based embedding that encapsulates the multi-dimensional characteristics of the user's credential profile. This embedding represents the user or account in a format that is both compact and computationally efficient, making it suitable for comparisons and analysis.

System 300 also determines a required embedding for an application entitlement by analyzing the application's access policies, permissions structure, and relevant metadata. These factors define the attributes and patterns that characterize valid access to the application. Using a similar embedding process, the system generates a vector-based representation of the application entitlement, which serves as the “required embedding.” This embedding encapsulates the attributes and relationships necessary for access, providing a standard against which user embeddings can be compared.

To determine whether to grant access to the application entitlement, system 300 compares the user embedding with the required embedding. This comparison evaluates whether the vector dimensions align, indicating that the user's credentials satisfy the application's requirements. If a dimensionality conflict arises—meaning certain attributes or patterns in the user's embedding are missing or misaligned with those in the required embedding—the system identifies the conflict and assesses its dependencies. For example, system 300 may detect that the conflict is linked to a missing credential attribute, such as a specific project affiliation or certification.

To resolve the conflict, system 300 determines a new embedding by requesting additional information from the user or system administrators. This may involve prompting the user to provide the missing attribute or automatically retrieving it from supplemental data sources, such as HR records or external directories. Once the new attribute is integrated into the user's credential data, the system generates an updated embedding and re-evaluates it against the required embedding. By iteratively addressing dimensionality conflicts and refining the embeddings, system 300 ensures accurate entitlement decisions, reducing errors and enabling seamless access management across applications. This dynamic approach enhances flexibility, scalability, and security in managing complex access requirements.

For example, FIG. 3 may show illustrative components improving network security across computer networks. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an embedding, a required embedding, a dimensionality conflict, and/or a dependency between the dimensionality conflict and a credential attribute).

To train a machine learning model to classify labeled feature inputs with known predictions, such as embeddings, required embeddings, dimensionality conflicts, or dependencies between conflicts and credential attributes, the system follows a supervised learning approach. First, it compiles a training dataset composed of labeled feature inputs derived from historical data. These inputs include user credential profiles, application entitlement requirements, access decisions, and recorded instances of dimensionality conflicts and their resolutions. Each training example pairs a set of input features with a known prediction, such as whether access was granted, the type of dimensionality conflict encountered, or the specific dependency between a conflict and a missing credential attribute.

The system preprocesses the input data to ensure consistency and suitability for model training. Features such as user attributes, entitlement requirements, and contextual metadata are encoded into numerical formats, such as vectors, embeddings, or categorical representations. For embeddings, techniques like word embeddings, autoencoders, or transformer-based models are used to convert high-dimensional attribute data into compact vector representations that capture the underlying relationships between features. Dimensionality conflicts and dependencies are also encoded as structured labels to guide the model's learning process.

Once the data is prepared, the system selects a machine learning model architecture suited to the classification task, such as a neural network, decision tree, or gradient-boosted model. During training, the model learns to map input features to the known predictions by minimizing a loss function, such as cross-entropy loss for classification tasks or mean squared error for regression-based dependencies. The training process involves backpropagation and gradient descent, iteratively adjusting the model's weights to optimize its performance. To enhance accuracy and prevent overfitting, the system employs techniques such as cross-validation, regularization, and data augmentation. It may also use feature importance analysis or dimensionality reduction to identify the most relevant inputs and streamline the model's complexity. After training, the model is validated on a separate dataset to evaluate its generalization to unseen data. By learning from labeled examples, the model becomes capable of accurately classifying new feature inputs, predicting embeddings, identifying dimensionality conflicts, and determining dependencies. This enables the system to dynamically assess access requirements, resolve conflicts, and refine entitlements, improving the efficiency and security of access management workflows

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an embedding, a required embedding, a dimensionality conflict, and/or a dependency between the dimensionality conflict and a credential attribute).

In some embodiments, the model (e.g., model 302) may automatically perform actions based on outputs 306. In some embodiments, the model (e.g., model 302) may not perform any actions. The output of the model (e.g., model 302) may be used to determine an embedding, a required embedding, a dimensionality conflict, and/or a dependency between the dimensionality conflict and a credential attribute.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

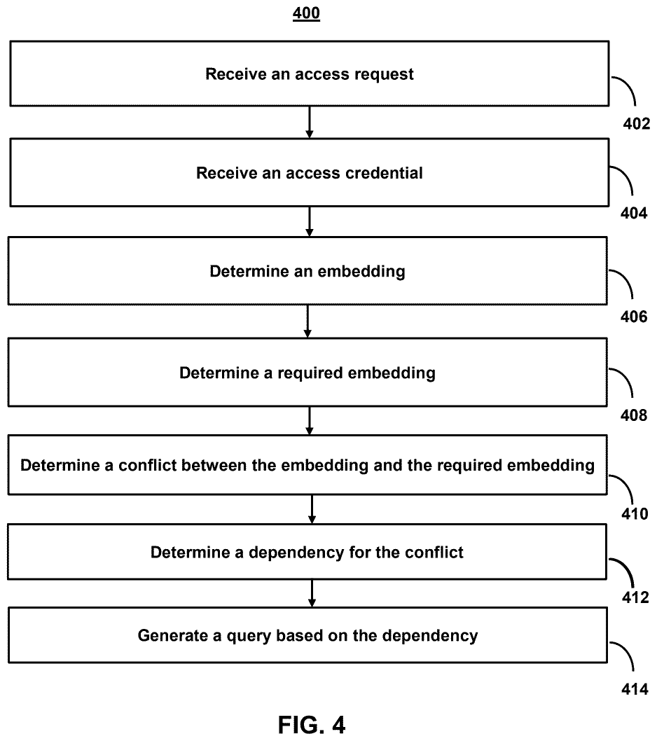

FIG. 4 shows a flowchart of the steps involved in improving network security across computer networks, in accordance with one or more embodiments. For example, the system may use process 400 (e.g., as implemented on one or more system components described above) in order to improve network security across computer networks when granting access entitlements to a plurality of applications.

At step 402, process 400 (e.g., using one or more components described above) receives an access request. For example, the system may receive, from a first account, a first access request for a first application entitlement. The may system receive a first access request for a first application entitlement from a first account through a structured communication process typically facilitated by APIs, authentication protocols, and access control mechanisms. When the user associated with the first account initiates an access request, such as logging into an application or attempting to perform a specific action, the application sends the request to the system. This request often includes essential details, such as the account's identifier (e.g., username, user ID), the application entitlement being requested (e.g., a specific permission, resource, or feature), and contextual metadata like the time of the request, location, and device details. The system processes the incoming request by verifying its authenticity and integrity. Authentication protocols, such as OAuth, OpenID Connect, or SAML, ensure that the request originates from a legitimate user and application. The request may also be accompanied by an access token or session ID that validates the user's identity and confirms their existing entitlements. If the token does not already include information about the entitlement being requested, the system queries its internal identity and access management (IAM) repository or policy engine to retrieve the account's associated attributes and current access rights. The system then extracts the specifics of the requested entitlement and evaluates it against the account's credentials, attributes, and existing entitlements. This process involves determining whether the user has the necessary permissions or roles to access the application entitlement, often by comparing the account's attributes and embeddings to the entitlement's requirements. The system may also log the access request for auditing and monitoring purposes, flagging it for further evaluation if it identifies inconsistencies or potential security risks.

As one example, when a new user joins, the system processes their SD attributes (e.g., SDDept=341 and SDJR=107) against predefined rules. The rules engine may evaluate the user's attributes and uses the first matching rule: “If SDDept=341 AND SDJR=107→Grant Ent1, Ent2, Ent3, Ent4, Ent5.” The system may provision the entitlements immediately. As no user-defined attributes (UD) exist at this stage, so no further rules execute.

At step 404, process 400 (e.g., using one or more components described above) receives an access credential. For example, the system may retrieve a first access credential profile for the first account. For example, the access credential profile retrieved for the account may include key attributes such as roles, entitlements, group memberships, and contextual metadata like department, location, or device types associated with the user. It may also include historical access logs, policy assignments, and conditional attributes relevant to access decisions. If the IAM repository is distributed across multiple data sources, such as directory services (e.g., Active Directory, LDAP) or cloud identity platforms (e.g., Okta, Azure AD), the system integrates data from these sources to construct a complete and up-to-date profile. To ensure accuracy and consistency, the system may apply normalization processes to standardize the retrieved data and resolve discrepancies between records from different sources. Depending on the system's architecture, it may also enrich the credential profile with real-time data, such as current session details or recent behavior analytics, to enhance its contextual understanding. Once retrieved and processed, the access credential profile is used as the foundation for evaluating entitlement requests, enforcing policies, and determining whether to grant or deny access to the requested application or resource. This structured retrieval process ensures that the system has a reliable and comprehensive basis for making secure and accurate access decisions.

For example, the system may automatically or manually update a user profile by adding UD attributes: “UDTAG1=‘Night Shift’; UDTAG2=‘Repo Specialist,’” which may be validated against eligible departments, ensuring security. Upon updating these attributes, the system re-evaluates the rule set and detects new applicable rules: “If SDDept=341 AND SDJR=107 AND UDTAG1=‘Night Shift’→Grant Ent6, Ent7” and “If SDDept=341 AND SDJR=107 AND UDTAG1=‘Night Shift’ AND UDTAG2=‘Repo Specialist’→Grant Ent8, Ent9.”

At step 406, process 400 (e.g., using one or more components described above) determines an embedding. For example, the system may determine a first embedding for the first access credential profile. The system may preprocess the credential profile to extract relevant features, such as roles, permissions, group memberships, job title, department, location, and historical access behavior. The extracted features are then encoded into numerical formats. Categorical attributes, such as roles or departments, are encoded using techniques like one-hot encoding, label encoding, or learned embeddings, while numerical attributes, such as session duration or access frequency, are normalized or scaled to ensure compatibility with the embedding model. The system utilizes a trained machine learning model, such as a neural network with an embedding layer or a transformer-based architecture, to map the processed features into a high-dimensional vector space. The model is typically trained on historical data to learn the relationships between attributes and how they influence access patterns. For example, the model might capture that certain roles often require specific permissions or that users in similar departments exhibit comparable access behaviors. By encoding these patterns, the embedding represents the credential profile as a compact, fixed-length vector that encapsulates both its individual characteristics and its relational context within the organization. Additionally, the system may enhance the embedding by incorporating contextual metadata, such as device type, time of access, or geolocation, to account for dynamic factors that influence access decisions. Dimensionality reduction techniques, such as principal component analysis (PCA), may also be applied to streamline the embedding while retaining its most critical features. Once generated, the embedding is stored and used for tasks such as comparing the credential profile to application entitlements, identifying anomalies, or clustering similar profiles. This embedding-based approach enables the system to process and analyze access credential profiles efficiently, supporting secure and accurate entitlement management at scale.

In some embodiments, the system may determine the first embedding for the first access credential profile by receiving entitlement criteria for the first application entitlement, filtering the first access credential profile based on the entitlement criteria to generate a first data subset, and encoding the first data subset. For example, the system may determine the first embedding for the first access credential profile by incorporating entitlement criteria for the first application entitlement to focus on relevant attributes and generate a refined, context-aware representation. This process begins by receiving entitlement criteria for the application entitlement, which define the attributes, roles, permissions, or contextual requirements necessary for access. These criteria are typically retrieved from the system's policy repository, application metadata, or predefined access rules, and they serve as a filter to isolate the most relevant elements of the access credential profile. Next, the system applies the entitlement criteria to the first access credential profile, filtering out attributes and metadata that are not pertinent to the entitlement. For example, if the application entitlement requires a specific certification, department affiliation, or project role, the system identifies and selects only the corresponding fields from the credential profile while excluding unrelated attributes. This filtering step produces a first data subset that focuses exclusively on the features required to evaluate the entitlement. Once the filtered data subset is generated, the system encodes it into a numerical embedding using a trained machine learning model, such as a neural network with an embedding layer or a transformer-based model. The model transforms the subset into a dense, fixed-length vector by capturing the relationships and dependencies between the selected attributes. For instance, it might encode not only the presence of a certification but also its relevance based on the role and department, reflecting the interplay of factors defined by the entitlement criteria. Dimensionality reduction techniques may be applied during encoding to streamline the representation while preserving critical information. The resulting embedding encapsulates the filtered credential profile in a compact and computationally efficient format tailored to the specific entitlement being evaluated. By dynamically filtering and encoding the credential data based on entitlement criteria, the system ensures that the embedding is both relevant and precise, enabling more accurate comparisons with required embeddings and facilitating secure, context-aware access decisions. This targeted approach enhances the system's ability to manage complex entitlements while reducing noise and computational overhead.

In some embodiments, the system may determine the first embedding for the first access credential profile by determining a first set of structured data points based on the first access credential profile, determining a first vector representation based on the first set of structured data points, and encoding the first vector representation to determine the first embedding. For example, the system may determine the first embedding for the first access credential profile by processing the profile into structured data, creating a vector representation, and encoding it into an embedding that captures the essential characteristics and relationships of the data. The system may begin by determining a first set of structured data points from the access credential profile. These data points are derived from the profile's attributes, such as roles, permissions, group memberships, certifications, job title, and contextual metadata like department or location. The system organizes these attributes into a structured format, ensuring consistency and compatibility with downstream processing. This step may involve data normalization, standardization of categorical values, and removal of irrelevant or redundant attributes. Next, the system converts the structured data points into a first vector representation, which is a numerical encoding of the profile's features. Each attribute is mapped to a corresponding numerical value or set of values. Categorical attributes are encoded using techniques like one-hot encoding or learned embeddings, while continuous attributes are scaled to ensure uniformity. For example, a “job title” might be represented as a learned vector capturing its semantic similarity to other roles, and a “department” might be one-hot encoded into a binary vector indicating membership. The resulting vector representation is a high-dimensional numerical structure that includes all relevant attributes from the credential profile. Finally, the system encodes the first vector representation into the first embedding using a trained machine learning model. This model, often a neural network with an embedding layer or an autoencoder, processes the vector representation to learn and compress the relationships and patterns among the attributes into a compact, fixed-length vector. The embedding captures not only individual attribute values but also the interactions and dependencies between them, such as how specific roles correlate with permissions or how group memberships influence access requirements. The encoding process may also involve dimensionality reduction to eliminate noise and enhance computational efficiency while retaining critical information.

In some embodiments, the system may determine the first embedding for the first access credential profile by determining a first set of structured data points based on the first access credential profile and scaling the first set of structured data points to determine the first embedding. For example, the system may analyze the access credential profile to identify a first set of structured data points. These data points include critical attributes such as roles, permissions, certifications, group memberships, and contextual metadata like department, job title, and location. The system organizes these attributes into a structured format that ensures consistency and readiness for further processing, often using predefined schemas or templates to maintain uniformity across profiles. Once the structured data points are identified, the system applies scaling techniques to normalize and encode the data into a numerical representation suitable for generating an embedding. Continuous attributes, such as access frequency or time of use, are scaled to a standard range (e.g., 0 to 1) to ensure uniform contribution across features. Categorical attributes, such as roles or departments, are mapped to numerical values using encoding methods like one-hot encoding or label encoding. For example, a “department” attribute might be transformed into a binary vector indicating the presence or absence of specific departments, while a “role” might be assigned a unique numerical identifier or transformed into a learned embedding through pretraining. The scaled data points are then aggregated into a single, compact vector that constitutes the first embedding. This embedding captures both the individual attributes and their relative importance within the profile, providing a compressed yet informative representation of the user's access credentials. By scaling the structured data points, the system ensures that attributes are represented in a way that maintains their relationships and preserves the meaningful distinctions necessary for downstream tasks, such as comparing the profile to application entitlements or detecting anomalies. Through this streamlined process of structuring and scaling data points, the system creates a robust and computationally efficient embedding that accurately represents the access credential profile, facilitating secure and effective accessing.

In some embodiments, the system may determine the first embedding for the first access credential profile by determining a first vector representation based on the first access credential profile and normalizing values in the first vector representation to determine the first embedding. For example, the system may analyze the access credential profile to identify key attributes such as roles, permissions, group memberships, certifications, and contextual metadata like department, job title, or location. These attributes are transformed into numerical features to form a first vector representation. This transformation involves encoding categorical attributes, such as roles or departments, into numerical formats using techniques like one-hot encoding or label encoding, and retaining continuous attributes, like access frequency or session duration, as-is or after appropriate scaling. Once the first vector representation is constructed, the system normalizes the values within the vector to ensure that all features are represented on a consistent scale. Normalization techniques, such as min-max scaling or z-score standardization, adjust the range of continuous values to eliminate discrepancies caused by varying scales or units. For instance, access frequency might be scaled to a range of 0 to 1, while categorical data encoded as binary values remain unchanged. This step ensures that no single attribute disproportionately influences the embedding due to differences in magnitude or measurement scale. After normalization, the system aggregates the adjusted vector values into a compact, fixed-length embedding. This embedding captures the relationships and interactions among the attributes, providing a holistic representation of the access credential profile. By normalizing the vector representation, the system improves the embedding's robustness and ensures that it is suitable for downstream tasks such as comparing to application entitlement embeddings, clustering profiles, or identifying anomalies.

At step 408, process 400 (e.g., using one or more components described above) determines a required embedding. For example, the system may retrieve a first required embedding for the first application entitlement. In some embodiments, the system may retrieve a first required embedding for the first application entitlement by accessing the predefined access policies, permissions, and contextual requirements associated with the application. This process begins with the system identifying the specific entitlement being requested, such as access to a feature, resource, or role within the application. The entitlement is mapped to its corresponding requirements, typically stored in a policy repository, entitlement catalog, or access management system. These requirements outline the attributes, roles, and contextual factors necessary for a user to qualify for the entitlement. The system then processes the retrieved entitlement data to encode it into a numerical representation, or embedding, that captures the relationships and dependencies within the access requirements. This involves extracting relevant features, such as required roles, conditional access rules, attribute constraints (e.g., department or project affiliation), and behavioral patterns typical of users granted this entitlement. The features are normalized, encoded, and transformed using a trained machine learning model, similar to the one used for generating user embeddings. The resulting vector, the “required embedding,” represents the entitlement's access requirements in a compact and computationally efficient format. If the application entitlement has dynamic or context-sensitive requirements, the system incorporates real-time data, such as the time of request, location, or current application state, to ensure the embedding reflects the current conditions. This dynamic embedding generation ensures alignment with policies that depend on situational factors. The required embedding is then stored or retrieved on-demand for comparison against user embeddings, enabling the system to evaluate whether the user's credentials align with the application's requirements. By encoding entitlement requirements into embeddings, the system enhances its ability to automate access decisions, detect mismatches, and support efficient and secure entitlement management across applications.

In some embodiments, the system may retrieve the first required embedding for the first application entitlement by receiving a required access credential, determining a second set of structured data points based on the required access credential, and encoding the required access credential to generate the first required embedding. For example, the system may receive the required access credential, which outlines the attributes, roles, permissions, or contextual requirements necessary to qualify for the application entitlement. This information is typically defined by the application's access policies, role-based permissions, or attribute-based conditions. The system then analyzes the required access credential to determine a second set of structured data points. These data points represent the critical features or criteria that define the entitlement, such as the roles needed, specific certifications, department affiliations, or any conditional access rules tied to location, device type, or access time. The system organizes these attributes into a structured format, ensuring consistency and alignment with the encoding process. This structure might also include priority or weight indicators if certain attributes carry more significance than others. After structuring the required access credential, the system encodes the data points into a numerical embedding using a trained machine learning model or a predefined encoding scheme. The model processes the data points to generate a compact, fixed-length vector that captures the relationships and dependencies among the attributes. For example, it might encode the interplay between required roles and conditional policies, reflecting how these elements work together to define the entitlement. Techniques like neural network embedding layers or learned vector representations are often used to ensure that the encoding reflects both the explicit requirements and the latent relationships embedded in the data. The resulting first required embedding serves as a precise representation of the application entitlement's access criteria. It can then be used to compare against user credential embeddings, enabling the system to evaluate whether a user meets the requirements for the entitlement. By structuring, encoding, and compactly representing the required access credential, the system ensures that entitlement criteria are efficiently processed and effectively utilized for secure and accurate access management.

At step 410, process 400 (e.g., using one or more components described above) determines a conflict between the embedding and the required embedding. For example, the system may determine a first dimensionality conflict between the first embedding and the first required embedding. In some embodiments, the system determines a first dimensionality conflict between the first embedding and the first required embedding by comparing the two vector representations to identify mismatches or misalignments in their dimensions. The process begins by ensuring that both embeddings are of the same dimensionality, meaning they have the same number of vector components, as this is a prerequisite for effective comparison. The embeddings represent different aspects of the access credential profile and the application entitlement requirements, such as roles, attributes, and contextual factors, encoded in a multi-dimensional space. The system compares the embeddings by evaluating the similarity or alignment of their corresponding dimensions, often using mathematical metrics such as cosine similarity, Euclidean distance, or Manhattan distance. Each dimension of the embedding typically corresponds to a specific attribute or a learned relationship between attributes. A dimensionality conflict occurs when certain dimensions in the user embedding fail to align with the corresponding dimensions in the required embedding, indicating a discrepancy between the user's credentials and the entitlement's requirements. For example, if a specific role or attribute required by the application is missing or incorrectly represented in the user embedding, the system flags this as a conflict. To further analyze the conflict, the system may decompose the embeddings into their individual components, identifying specific dimensions where the differences occur. It also evaluates the severity of the conflict by assessing the weight or importance of the misaligned dimensions, which can be determined based on the application's policies or the trained model's understanding of feature importance. If necessary, the system logs the conflict details and prepares to resolve it by identifying dependencies between the misaligned dimensions and additional credential attributes that may be missing or incorrectly encoded.

In some embodiments, the system may determine the first dimensionality conflict between the first embedding and the first required embedding by determining a first required vector value based on the first required embedding and parsing the first embedding for the first required vector value. For example, the system may extract a first required vector value from the first required embedding, which represents a specific attribute or relationship essential for meeting the criteria of the application entitlement. This required vector value is a component of the required embedding, corresponding to a particular dimension that encodes a critical feature, such as a role, permission, or contextual attribute. Once the required vector value is identified, the system parses the first embedding (representing the user's access credential profile) to locate the corresponding dimension and determine whether it matches the required value. Parsing involves examining the user embedding's vector representation to evaluate the magnitude, presence, or state of the specific attribute encoded in the dimension. For example, if the required embedding specifies a value indicating that a certain certification is mandatory, the system checks whether the user embedding includes a matching certification value in the corresponding vector dimension. A dimensionality conflict may arise when the value in the user embedding fails to align with the required vector value. This misalignment may indicate a missing attribute, an incorrect or insufficient value, or an inconsistency between the user's credentials and the entitlement's requirements. The system logs this conflict and further analyzes its nature, such as whether it is due to an absent role, a mismatched attribute, or a misconfigured permission. This analysis provides a foundation for resolving the conflict, such as by prompting the user for additional information, querying supplementary data sources, or revising the credential profile. By determining the first required vector value and systematically parsing the user embedding for alignment, the system can pinpoint specific dimensionality conflicts, enabling precise evaluation of access requests and supporting dynamic resolution workflows. This approach ensures secure and accurate entitlement management, even in complex and multi-faceted access scenarios.

In some embodiments, the system may determine the first dimensionality conflict between the first embedding and the first required embedding by retrieving a threshold similarity value, wherein the threshold similarity value is based on the first application entitlement, comparing the first embedding and the first required embedding, determining a first similarity value based on comparing the first embedding and the first required embedding, and comparing the threshold similarity value to the first similarity value. For example, the system may retrieve a threshold similarity value specific to the first application entitlement. This threshold is predefined or dynamically calculated based on the application's access policies and represents the minimum similarity score required to grant access. It reflects how closely a user's access credential profile must match the application's entitlement requirements in terms of roles, attributes, and other contextual factors. Next, the system compares the first embedding (representing the user's access credential profile) with the first required embedding (representing the application's entitlement criteria) using a similarity measurement technique, such as cosine similarity, Euclidean distance, or another metric appropriate for comparing vector data. This comparison generates a first similarity value that quantifies the degree of alignment between the two embeddings. For instance, a cosine similarity score close to 1 indicates a high degree of alignment, whereas a lower score suggests significant discrepancies. The system then evaluates the first similarity value against the retrieved threshold similarity value. If the similarity value meets or exceeds the threshold, it indicates that the user's credentials align sufficiently with the entitlement requirements, and access can be granted. However, if the similarity value falls below the threshold, the system identifies this as a dimensionality conflict. This conflict signals that the user embedding lacks the required alignment with the entitlement embedding, which may be due to missing attributes, insufficient credentials, or other misalignments. By using a threshold similarity value to evaluate the embeddings, the system ensures that access decisions are made with precision and consistency. This approach not only identifies dimensionality conflicts but also quantifies the extent of the misalignment, enabling further analysis to determine the root cause. If necessary, the system can take corrective actions, such as requesting additional information from the user or refining the credential profile, to resolve the conflict and facilitate accurate entitlement management.

In some embodiments, the system may determine the first dimensionality conflict between the first embedding and the first required embedding by retrieving a threshold frequency, wherein the threshold frequency is based on the first application entitlement, determining a first required vector value based on the first required embedding, determining a first frequency of the first required vector value in the first embedding, and comparing the threshold frequency to the first frequency. For example, the system may retrieve a threshold frequency specific to the first application entitlement. This threshold defines the minimum required occurrence or representation of a key attribute or feature (e.g., a role, permission, or contextual element) within the embedding. The threshold frequency is derived from the application's entitlement policies, historical access patterns, or compliance requirements. The system then identifies the first required vector value from the first required embedding, representing the attribute or feature that is critical to the entitlement. This value encapsulates specific access criteria, such as the presence of a certification, group membership, or conditional requirement. Next, the system calculates the frequency of the first required vector value within the user's embedding by analyzing how often or strongly the required attribute is represented in the vector dimensions. For example, the system might determine that the embedding includes partial or repeated references to the required attribute, which may occur due to overlapping roles, permissions, or redundant features in the credential profile. The calculated frequency reflects the extent to which the user's embedding satisfies the specific requirement. Finally, the system compares the calculated frequency to the threshold frequency. If the user embedding's frequency meets or exceeds the threshold, it indicates sufficient representation of the required attribute, and no dimensionality conflict is identified. However, if the frequency falls below the threshold, the system flags a dimensionality conflict, signifying that the user embedding does not adequately satisfy the requirement. This conflict may be due to missing, incomplete, or insufficient representation of the required attribute in the user's credential profile. By using a threshold frequency as a benchmark, the system ensures that critical attributes are not only present but sufficiently represented to meet the entitlement's requirements. This approach provides a nuanced method for detecting dimensionality conflicts, supporting accurate access decisions, and enabling corrective actions, such as requesting additional information or refining the user's embedding to resolve the conflict.

At step 412, process 400 (e.g., using one or more components described above) determines a dependency for the conflict. For example, the system may determine a dependency between the first dimensionality conflict and a credential attribute. In some embodiments, the system determines a dependency between the first dimensionality conflict and a credential attribute by analyzing the misalignment between the user's embedding and the required embedding and tracing it back to specific features in the access credential profile. Each dimension in an embedding corresponds to particular attributes, roles, or relationships derived from the underlying credential data. When a dimensionality conflict is detected—indicating a discrepancy in one or more dimensions—the system evaluates which attributes contributed to the conflict by mapping the conflicting dimensions back to their source data in the credential profile. This mapping process involves examining the model's feature importance or attention weights, which highlight the attributes most strongly associated with each dimension in the embeddings. For example, if the conflicting dimension corresponds to a missing role or an unmet condition (e.g., project affiliation or certification), the system identifies the attribute tied to that dimension as a potential cause of the conflict. Dependency analysis is further refined by evaluating policy rules and historical access patterns to determine whether the attribute in question is a prerequisite for satisfying the entitlement's requirements. The system may also leverage its training data and learned relationships to predict dependencies. For instance, if the dimensionality conflict indicates a missing certification required for access, the model might infer this dependency based on similar cases in the dataset. If the conflict involves a combination of attributes, such as a specific role combined with a location constraint, the system assesses these interdependencies to isolate the critical missing or misaligned attribute. Once a dependency is identified, the system determines how to resolve it, such as by requesting additional information from the user (e.g., uploading a certification document), querying external data sources (e.g., HR systems or project management tools), or suggesting updates to the credential profile. By pinpointing dependencies, the system can dynamically address conflicts, ensuring that access decisions are both accurate and aligned with organizational policies, while reducing administrative overhead and maintaining security.

In some embodiments, the system may determine the dependency between the first dimensionality conflict and the credential attribute by determining a first difference in the first embedding and the first required embedding, determining a first vector value corresponding to the first difference, and determining the credential attribute corresponds to the first vector value. For example, the system may determine the dependency between the first dimensionality conflict and a credential attribute by analyzing the difference between the user's embedding and the required embedding, isolating the source of the conflict, and tracing it back to the specific attribute responsible. The process begins by identifying a first difference between the two embeddings, which is calculated by comparing their vector values dimension by dimension. This comparison reveals discrepancies in specific dimensions, such as mismatches, missing values, or insufficient representation of required attributes. Next, the system isolates the first vector value corresponding to the identified difference. This vector value represents a dimension in the embedding that is directly linked to the attribute or feature causing the conflict. For example, if the required embedding includes a high value in a dimension representing a specific certification, and the user's embedding has a significantly lower or zero value in the same dimension, the system identifies this vector value as the source of the conflict. The system then maps the first vector value back to the underlying data or features in the access credential profile to determine the credential attribute associated with the conflict. Each vector dimension is derived from specific attributes in the credential profile, such as roles, permissions, group memberships, or certifications. Using this mapping, the system identifies the attribute that corresponds to the conflicting vector value. For instance, the system might determine that the conflict arises because the user's profile lacks a required certification or group affiliation represented by the vector dimension. By pinpointing the exact attribute tied to the conflict, the system establishes a dependency between the dimensionality conflict and the missing or insufficient credential attribute. This dependency analysis enables the system to recommend or take corrective actions, such as prompting the user to update their profile, querying additional data sources, or recalibrating the embedding. This approach ensures precise identification and resolution of access conflicts, supporting accurate entitlement decisions and robust access management.

In some embodiments, the system may determine the dependency between the first dimensionality conflict and the credential attribute by receiving an embedding algorithm used to generate embeddings for known attribute and training a model to determine an attribute based on a known embedding and the embedding algorithm. For example, the system may receive the embedding algorithm, which defines the methodology for transforming credential attributes into vector representations. This algorithm may involve techniques such as neural network-based embedding layers, word embeddings (e.g., Word2Vec), or transformer-based models, and it establishes the relationship between raw attributes and their encoded representations in the embedding space. The system then collects a dataset of known attributes and their corresponding embeddings, generated using the embedding algorithm. This dataset provides a training foundation for the model, ensuring it learns the reverse mapping—from an embedding vector back to its originating attributes. The training process involves feeding the model pairs of embeddings and their associated attributes, allowing it to learn patterns and relationships embedded in the vector space. For instance, the model might learn that a specific cluster of vector values corresponds to a particular role, certification, or group membership. Once trained, the model can analyze embeddings and predict the attributes they represent. In the context of a dimensionality conflict, the system uses this trained model to interpret the conflicting dimension in the embedding and determine the attribute that corresponds to the discrepancy. For example, if the embedding conflict arises from a missing or misaligned vector value, the model can identify the credential attribute (e.g., “project affiliation” or “security clearance”) tied to that dimension. This prediction establishes the dependency between the dimensionality conflict and the underlying attribute. By leveraging the embedding algorithm and a reverse-mapping model, the system gains the ability to trace conflicts back to specific attributes accurately. This approach not only enhances conflict resolution by pinpointing missing or misaligned data but also facilitates dynamic updates to credential profiles, ensuring that embeddings remain aligned with entitlement requirements and supporting robust and scalable access management workflows.

In some embodiments, the system may determine the dependency between the first dimensionality conflict and the credential attribute by receiving known attributes labeled with known embeddings and training a model to determine an attribute corresponding to a difference between inputted embedding and an inputted required embedding. For example, the system may receive a dataset where known attributes are paired with their respective embeddings. These embeddings are generated using a predefined algorithm that encodes attributes into vector representations, capturing their relationships and contextual significance within the credential space. Using this dataset, the system trains a machine learning model to learn the mapping between embedding differences and the attributes they represent. The model is designed to identify patterns in the embedding space that correspond to specific attributes. During training, the system inputs pairs of embeddings—representing a user profile and a required profile—and labels the differences with the corresponding attributes that explain the misalignment. For example, if a particular dimension in the embedding vector relates to a missing certification, the model learns to associate deviations in that dimension with the certification attribute. Once trained, the model is applied to input embeddings to analyze conflicts. When a dimensionality conflict is detected—represented by a difference between the inputted embedding (user's credential profile) and the inputted required embedding (application entitlement)—the model evaluates the conflicting dimensions and predicts the attribute associated with the difference. This prediction identifies the specific credential attribute (e.g., “job role,” “department,” or “project affiliation”) causing the misalignment. This method allows the system to establish a direct dependency between the dimensionality conflict and the underlying credential attribute. By mapping embedding differences back to their root attributes, the system can take targeted actions to resolve the conflict, such as prompting for additional information, updating the user profile, or refining access policies. This approach enhances the system's ability to dynamically address access conflicts, ensuring accurate entitlement decisions and efficient access management.

In some embodiments, the system may determine the dependency between the first dimensionality conflict and the credential attribute by generating a dependency mapping of known embedding values and credential attributes and inputting the first dimensionality conflict into the dependency mapping. For example, the system may create a dependency mapping using a dataset of known embeddings and their associated credential attributes. These embeddings are generated from access credential profiles using a predefined algorithm that encodes attributes (e.g., roles, permissions, certifications) into vector representations. Each embedding value or dimension is annotated with the specific attribute it represents, forming a comprehensive mapping that defines the relationship between the embedding space and the credential attributes. When the system detects a first dimensionality conflict between a user's embedding and a required embedding, it analyzes the specific vector dimension or value responsible for the misalignment. The system then inputs this dimensionality conflict into the dependency mapping to identify the attribute linked to the conflicting dimension. For example, if the conflict arises from a missing or incorrect value in the user's embedding, the mapping reveals which credential attribute (e.g., “security clearance” or “project membership”) corresponds to the misaligned vector value. This approach allows the system to trace the source of the conflict directly to its root attribute, enabling precise identification of the dependency. By leveraging the dependency mapping, the system can quickly determine which credential attribute needs to be updated, verified, or added to resolve the conflict. For instance, if the mapping indicates that the conflict is due to a missing certification, the system can prompt the user to provide the required documentation or check external data sources for verification. By generating and applying a dependency mapping, the system simplifies the process of diagnosing and resolving dimensionality conflicts, ensuring accurate and efficient entitlement decisions. This method reduces ambiguity, enhances the scalability of access management, and provides a structured framework for handling complex relationships between embeddings and credential attributes.

At step 414, process 400 (e.g., using one or more components described above) generates a query based on the dependency. For example, the system may query the first account for the credential attribute. In some embodiments, the system may query the first account for the missing or incomplete credential attribute by initiating a targeted request through predefined communication channels. When the system identifies a dimensionality conflict and determines the specific attribute required to resolve it, it generates a query tailored to the missing attribute. This query includes details about the attribute in question, why it is needed, and any relevant instructions or contextual information to guide the account holder in providing it. For example, if the system identifies that a certification is missing for access to a particular entitlement, it may ask the user to upload a copy of the certification or provide an associated identification number. The query is delivered through the user's preferred interaction channel, such as a secure web portal, email, or an in-application notification. The system ensures the request is clear and actionable, often using dynamic forms or guided workflows to simplify the user experience. These workflows may include drop-down menus, text fields, or file upload options, allowing the user to provide the attribute with minimal effort. To maintain security and privacy, the system uses encrypted communication channels and limits the scope of the query to the specific attribute needed to resolve the conflict. If the missing attribute requires validation or enrichment, the system may include instructions for the user to confirm its accuracy or context. For example, a user might be prompted to verify their department affiliation or provide additional documentation to support their claim. The system tracks the query's status, ensuring that the request is acknowledged and the attribute is updated in the credential profile once provided. Additionally, if the query remains unanswered within a certain timeframe, the system may send reminders or escalate the request to an administrator for further action. By structuring the query process to be efficient, secure, and user-friendly, the system minimizes delays in resolving dimensionality conflicts, improves the accuracy of credential profiles, and ensures timely and appropriate access decisions.

As it relates to the example above, the system may employ machine learning (ML)-based clustering to identify patterns in access provisioning. For example, if the system detects that 90% of users with the same SD and UD attributes have Ent10. The system flags this insight and notifies the business owner of Ent10, asking whether: “Ent10 should be incorporated into the existing rule.” If approved, Ent10 is added to the rule, ensuring future users meeting these attributes receive it automatically. The remaining 10% of eligible users without Ent10 receive it in the next rule execution.

In some embodiments, the system may query the first account for the credential attribute by inputting the credential attribute into a model to generate a first output, wherein the model is trained to generate queries for requested attributes and generating a query to the first account based on the first output. For example, the system may identify a specific credential attribute required to resolve a dimensionality conflict or fulfill an entitlement criterion. This attribute is input into a trained model designed to create contextually relevant and actionable queries. The model has been trained on historical data that includes examples of credential attributes, associated query responses, and the linguistic or structural characteristics of effective queries. Upon receiving the input attribute, the model processes it and generates a first output, which represents the structure and content of a query tailored to the specific attribute. The output incorporates details such as the type of information requested, why it is needed, and instructions for providing it. For example, if the missing attribute is a certification, the query might include a request for the certification name, an upload field for documentation, and an explanation of its relevance to the requested entitlement. The system then converts the model's output into a formatted query and delivers it to the first account through appropriate communication channels, such as a secure web portal, email, or in-app notification. The query is designed to be clear and concise, ensuring that the user understands the request and can respond efficiently. For instance, the query might include pre-populated fields, drop-down menus, or links to additional resources to simplify the process for the user. By using a model trained to generate context-aware queries, the system ensures that requests for credential attributes are specific, relevant, and easy to act on. This approach reduces the likelihood of confusion or delays, enabling users to quickly provide the required information and facilitating the resolution of dimensionality conflicts or the fulfillment of access requirements. This streamlined process enhances the efficiency and accuracy of credential management, supporting robust and secure entitlement workflows.

In some embodiments, the system may determine whether an account or entity has reached a threshold level of trust before querying for credential attributes by leveraging a combination of predefined policies, historical interactions, and verification mechanisms. Initially, the system assesses the trustworthiness of the account based on factors such as prior authentication methods, the reliability of provided credentials, and the account's behavior patterns. Risk-based authentication can also play a role, where factors like geolocation, device fingerprinting, and login time anomalies are analyzed to gauge trust levels. Additionally, the system may consult external or federated trust frameworks, such as digital certificates, reputation scores, or trust signals from third-party providers. If the evaluated parameters align with the threshold requirements, the system considers the account trustworthy enough to request specific credential attributes. This layered approach helps ensure that sensitive queries are made only to accounts that have demonstrated adequate legitimacy, reducing the risk of unauthorized access or data exposure.

In some embodiments, when a system receives a credential attribute, it determines a cluster of additional supplemental metadata accessible via channels with the same trust level by analyzing the relationships between the received attribute and the metadata defined in its access control policies or trust framework. These policies often include mappings of attributes to specific trust levels, outlining which supplemental metadata can be accessed under equivalent security conditions. The system evaluates the received credential attribute against these mappings, identifying associated metadata clusters that share the same trust designation. Additionally, the system may leverage contextual information, such as the purpose of the query, the permissions granted to the requester, or the scope of the data-sharing agreement. By ensuring that supplemental metadata is only accessible through channels with equivalent trust levels, the system maintains data security and privacy while facilitating seamless access to related information. This dynamic approach allows for efficient retrieval of relevant data while adhering to established trust boundaries.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for improving network security across computer networks when granting access entitlements to a plurality of applications.
2. The method of any one of the preceding embodiments, further comprising: receiving, from a first account, a first access request for a first application entitlement; retrieving a first access credential profile for the first account; determining a first embedding for the first access credential profile; retrieving a first required embedding for the first application entitlement; determining a first dimensionality conflict between the first embedding and the first required embedding; determining a dependency between the first dimensionality conflict and a credential attribute; and querying the first account for the credential attribute.
3. The method of any one of the preceding embodiments, wherein determining the first embedding for the first access credential profile further comprises: receiving entitlement criteria for the first application entitlement; filtering the first access credential profile based on the entitlement criteria to generate a first data subset; and encoding the first data subset.
4. The method of any one of the preceding embodiments, wherein determining the first embedding for the first access credential profile further comprises: determining a first set of structured data points based on the first access credential profile; determining a first vector representation based on the first set of structured data points; and encoding the first vector representation to determine the first embedding.
5. The method of any one of the preceding embodiments, wherein determining the first embedding for the first access credential profile further comprises: determining a first set of structured data points based on the first access credential profile; and scaling the first set of structured data points to determine the first embedding.
6. The method of any one of the preceding embodiments, wherein determining the first embedding for the first access credential profile further comprises: determining a first vector representation based on the first access credential profile; and normalizing values in the first vector representation to determine the first embedding.
7. The method of any one of the preceding embodiments, wherein retrieving the first required embedding for the first application entitlement further comprises: receiving a required access credential; determining a second set of structured data points based on the required access credential; and encoding the required access credential to generate the first required embedding.
8. The method of any one of the preceding embodiments, wherein determining the first dimensionality conflict between the first embedding and the first required embedding further comprises: determining a first required vector value based on the first required embedding; and parsing the first embedding for the first required vector value.
9. The method of any one of the preceding embodiments, wherein determining the first dimensionality conflict between the first embedding and the first required embedding further comprises: retrieving a threshold similarity value, wherein the threshold similarity value is based on the first application entitlement; comparing the first embedding and the first required embedding; determining a first similarity value based on comparing the first embedding and the first required embedding; and comparing the threshold similarity value to the first similarity value.
10. The method of any one of the preceding embodiments, wherein determining the first dimensionality conflict between the first embedding and the first required embedding further comprises: retrieving a threshold frequency, wherein the threshold frequency is based on the first application entitlement; determining a first required vector value based on the first required embedding; determining a first frequency of the first required vector value in the first embedding; and comparing the threshold frequency to the first frequency.
11. The method of any one of the preceding embodiments, wherein determining the dependency between the first dimensionality conflict and the credential attribute further comprises: determining a first difference in the first embedding and the first required embedding; determining a first vector value corresponding to the first difference; and determining the credential attribute corresponds to the first vector value.
12. The method of any one of the preceding embodiments, wherein determining the dependency between the first dimensionality conflict and the credential attribute further comprises: receiving an embedding algorithm used to generate embeddings for known attribute; and training a model to determine an attribute based on a known embedding and the embedding algorithm.
13. The method of any one of the preceding embodiments, wherein determining the dependency between the first dimensionality conflict and the credential attribute further comprises: receiving known attributes labeled with known embeddings; and training a model to determine an attribute corresponding to a difference between inputted embedding and an inputted required embedding.
14. The method of any one of the preceding embodiments, wherein determining the dependency between the first dimensionality conflict and the credential attribute further comprises: generating a dependency mapping of known embedding values and credential attributes; and inputting the first dimensionality conflict into the dependency mapping.
15. The method of any one of the preceding embodiments, wherein querying the first account for the credential attribute further comprises: inputting the credential attribute into a model to generate a first output, wherein the model is trained to generate queries for requested attributes; and generating a query to the first account based on the first output.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for improving network security across computer networks when granting access entitlements to a plurality of applications, the system comprising:
one or more processors; and
one or more non-transitory, computer-readable media comprising instructions that, when executed by the one or more processors, cause operations comprising:
receiving, from a first computer of a first computer network, a first access request, wherein the first access request requests access for a first application entitlement, of a plurality of application entitlements, for a first account;
retrieving, by a second computer of the first computer network, a first access credential profile for the first account, wherein the first access credential profile comprises a plurality of credential data corresponding to the first account, and wherein the first access credential profile comprises a first trust level;
processing the plurality of credential data to determine a first embedding, wherein the first embedding comprises first vector data;
retrieving a first required embedding for the first application entitlement;
determining a first dimensionality conflict between the first embedding and the first required embedding;
determining a dependency between the first dimensionality conflict and a credential attribute cluster that has the first trust level;
querying the first account for a credential attribute from the credential attribute cluster; and
receiving, via a user interface, the credential attribute.

2. A method for improving network security across computer networks when granting access entitlements to a plurality of applications, the method comprising:
receiving, from a first account, a first access request for a first application entitlement;
retrieving a first access credential profile for the first account;
determining a first embedding for the first access credential profile;
retrieving a first required embedding for the first application entitlement;
determining a first dimensionality conflict between the first embedding and the first required embedding;
determining a dependency between the first dimensionality conflict and a credential attribute; and
querying the first account for the credential attribute.

3. The method of claim 2, wherein determining the first embedding for the first access credential profile further comprises:
receiving entitlement criteria for the first application entitlement;
filtering the first access credential profile based on the entitlement criteria to generate a first data subset; and
encoding the first data subset.

4. The method of claim 2, wherein determining the first embedding for the first access credential profile further comprises:
determining a first set of structured data points based on the first access credential profile;
determining a first vector representation based on the first set of structured data points; and
encoding the first vector representation to determine the first embedding.

5. The method of claim 2, wherein determining the first embedding for the first access credential profile further comprises:
determining a first set of structured data points based on the first access credential profile; and
scaling the first set of structured data points to determine the first embedding.

6. The method of claim 2, wherein determining the first embedding for the first access credential profile further comprises:
determining a first vector representation based on the first access credential profile; and
normalizing values in the first vector representation to determine the first embedding.

7. The method of claim 2, wherein retrieving the first required embedding for the first application entitlement further comprises:
receiving a required access credential;
determining a second set of structured data points based on the required access credential; and
encoding the required access credential to generate the first required embedding.

8. The method of claim 2, wherein determining the first dimensionality conflict between the first embedding and the first required embedding further comprises:
determining a first required vector value based on the first required embedding; and
parsing the first embedding for the first required vector value.

9. The method of claim 2, wherein determining the first dimensionality conflict between the first embedding and the first required embedding further comprises:
retrieving a threshold similarity value, wherein the threshold similarity value is based on the first application entitlement;
comparing the first embedding and the first required embedding;
determining a first similarity value based on comparing the first embedding and the first required embedding; and
comparing the threshold similarity value to the first similarity value.

10. The method of claim 2, wherein determining the first dimensionality conflict between the first embedding and the first required embedding further comprises:
retrieving a threshold frequency, wherein the threshold frequency is based on the first application entitlement;
determining a first required vector value based on the first required embedding;
determining a first frequency of the first required vector value in the first embedding; and
comparing the threshold frequency to the first frequency.

11. The method of claim 2, wherein determining the dependency between the first dimensionality conflict and the credential attribute further comprises:
determining a first difference in the first embedding and the first required embedding;
determining a first vector value corresponding to the first difference; and
determining the credential attribute corresponds to the first vector value.

12. The method of claim 2, wherein determining the dependency between the first dimensionality conflict and the credential attribute further comprises:
receiving an embedding algorithm used to generate embeddings for known attribute; and
training a model to determine an attribute based on a known embedding and the embedding algorithm.

13. The method of claim 2, wherein determining the dependency between the first dimensionality conflict and the credential attribute further comprises:
receiving known attributes labeled with known embeddings; and
training a model to determine an attribute corresponding to a difference between inputted embedding and an inputted required embedding.

14. The method of claim 2, wherein determining the dependency between the first dimensionality conflict and the credential attribute further comprises:
generating a dependency mapping of known embedding values and credential attributes; and
inputting the first dimensionality conflict into the dependency mapping.

15. The method of claim 2, wherein querying the first account for the credential attribute further comprises:
inputting the credential attribute into a model to generate a first output, wherein the model is trained to generate queries for requested attributes; and
generating a query to the first account based on the first output.

16. One or more non-transitory, computer-readable media comprising instructions that, when executed by one or more processors, cause operations comprising:
determining a first embedding for a first access credential profile;
retrieving a first required embedding for a first application entitlement;
determining a first dimensionality conflict between the first embedding and the first required embedding;
determining a dependency between the first dimensionality conflict and a credential attribute; and
querying a first account for the credential attribute.

17. The one or more non-transitory, computer-readable media of claim 16, wherein determining the first embedding for the first access credential profile further comprises:
filtering the first access credential profile based on entitlement criteria to generate a first data subset; and
encoding the first data subset.

18. The one or more non-transitory, computer-readable media of claim 16, wherein determining the first embedding for the first access credential profile further comprises:
determining a first vector representation based on the first access credential profile; and
encoding the first vector representation to determine the first embedding.

19. The one or more non-transitory, computer-readable media of claim 16, wherein determining the first embedding for the first access credential profile further comprises:
determining a first set of structured data points based on the first access credential profile; and
scaling the first set of structured data points to determine the first embedding.

20. The one or more non-transitory, computer-readable media of claim 16, wherein determining the first embedding for the first access credential profile further comprises:
determining a first vector representation based on the first access credential profile; and
normalizing values in the first vector representation to determine the first embedding.
